(19) United States
(12) Patent Application Publication
(10) Pub. No.: US 2009/0274807 A1
(43) Pub. Date: Nov. 5, 2009

(54) MANUFACTURING METHOD FOR RICE PIZZA

(76) Inventor: Dae-Gu Lee, Seoul (KR)

Correspondence Address: IPLA P.A., 3580 WILSHIRE BLVD., 17TH FLOOR, LOS ANGELES, CA, 90010, US

(21) Appl. No.: 12/302,235

(22) PCT Filed: Apr. 26, 2007
(86) PCT No.: PCT/KR07/02055

§ 371 Date: Nov. 24, 2008

(30) Foreign Application Priority Data
May 29, 2006 (KR) 10-2006-0047937
Nov. 3, 2006 (KR) 10-2006-0108099

(51) Int. Cl. A23L 1/10

(52) U.S. Cl. 426/275

(57) ABSTRACT

Disclosed is a method of providing rice pizza that integrates pizza with sauce made from Korea's traditional pastes. The rice pizza of the present invention incorporates ingredients such as a piece of rice cake, various pastes, such as thick soy paste mixed with red peppers, fermented soybean paste, and soy sauce. As a result, the present invention converts some of pizza's adult-disease-generating ingredients into Korea's traditional high-quality food products, which promotes rice consumption among young people and ultimately at home.

### TECHNICAL FIELD

The present invention relates to a manufacturing method for rice pizza. More particularly, the present invention pertains to a manufacturing method for rice pizza that combines rice pizza with sauce, including steamed rice cake and traditional Korean paste.

### BACKGROUND ART

Generally, rice cake is processed food made of rice and other cereals, divided into many groups depending on the manufacturing method. An example is rice cake, the manufacturing method of which is as follows. First, cereal powder is placed into an earthenware steamer to make steamed rice cake by steaming. Then, steamed rice cake is formed into a predetermined shape through extrusive cutting.

Pizza is a food that is widely loved around the world. The manufacturing method thereof is as follows. First, a large and round shaped piece of dough, made from wheat flour and expanded using yeast, is prepared. Second, many favorite ingredients, such as tomato sauce, olives, anchovies, mushrooms, and sausage, are placed on the dough. Third, grated Mozzarella cheese is scattered on top of all the ingredients. Lastly, the dough is baked in an oven heated to 200° C. for a period ranging from 20˜30 minutes until the scattered cheese melts.

Pizza has been rapidly adopted by young people through many corporate chains, and has given rise to a change in food consumption patterns.

However, fast food, including pizza, is a typical junk food that causes various adult diseases.

Meanwhile, consumption of rice among Korean people is decreasing due to the influx of Western-style food such as pizza. Even worse, agricultural districts are becoming impoverished due to changes in the Korean government's rice importation policy.

There have been many attempts to address such problems by integrating traditional food with fast food, thus increasing the quality of food and rice consumption. However these approaches failed to gain acceptance in the market, and were removed therefrom, so the integration between.

### DISCLOSURE OF INVENTION

### Technical Problem

Accordingly, the present invention has been made keeping in mind the above problems occurring in the prior art, and an object of the present invention is to provide a rice pizza that contains traditional pastes, such as thick soy paste mixed with red peppers, fermented soybean paste, and soy sauce. As a result, this converts pizza's adult disease generating ingredients into a high-quality food product to promote rice consumption among young people and ultimately provide rice pizza that promotes rice consumption at home.

### Technical Solution

In order to accomplish the above object, the present invention provides a manufacturing method for rice pizza, comprising: a step of preparing steamed rice cake by placing 1 wt part of rice powder into an earthenware steamer, performing steaming at 100° C.˜250° C. for 15˜40 minutes to make steamed rice cake, extruding the steamed rice cake by use of an extruder, and cutting the extrudate into round or square shaped dough; a step of applying 0.05˜0.15 wt parts of sauce on top of the rice cake-based dough, said sauce being selected from a group consisting of Korean hot pepper paste, fermented soybean paste, and soy sauce; a topping step of placing 0.03˜0.08 wt parts of topping on top of the sauce, said topping being selected from a group consisting of seafood, meat, fried kimchi and combinations thereof; a step of applying additional toppings comprising 0.02˜0.05 wt parts of fruit selected from a group consisting of pineapple, apple, peach, watermelon, orange, strawberry, kiwi fruit, pear, persimmon, tomato and combinations thereof, and favorite ingredients comprising one or more ingredients selected from among 0.02˜0.05 wt parts of sausages, 0.02˜0.05 wt parts of mushrooms, 0.02˜0.05 wt parts of olives, 0.02˜0.05 wt parts of green pepper, 0.02˜0.05 wt parts of potato, 0.02˜0.05 wt parts of sweet pumpkin, and 0.02˜0.05 wt parts of sweet potato, on top of the topping; and a step of placing 0.10˜0.22 wt parts of mozzarella cheese on top of the favorite ingredients and baking the pizza in an oven preheated to 270° C.˜330° C. for 2˜3 minutes.

In an embodiment of the method, 1 wt part of rice powder is combined with 0.01˜0.30 wt parts of a food additive.

Preferably, the food additive is selected from a group consisting of green tea powder, banaba powder, blackberry powder, arrowroot powder, herb powder, cocoa powder, caramel powder, schizandra Berry Powder, cherry powder, gardenia powder, mugwort powder, red hot peppers powder powder, calostoma powder, jujube powder, sweetened red-bean paste powder, corn powder and combinations thereof.

In an embodiment of the present invention, more than one rice cake-based dough pieces may be prepared. In the case that there are two or more pieces of dough, 0.04˜0.15 wt parts of mozzarella cheese is placed between the dough pieces.

In an embodiment of the present invention, the Korean hot pepper sauce is prepared by: a first step of condensing 0.0007˜0.0009 wt parts of olive oil and 0.010˜0.015 wt parts of minced beef in a preheated pan at 100° C.˜140° C. for 15 seconds˜1 minute; a second step of panbroiling 0.0025˜0.0029 wt parts of chopped garlic, 0.0025˜0.0029 wt parts of chopped onion, 0.00050˜0.00060 wt parts of chopped leek, 0.0025˜0.0029 wt parts of chopped ginger, 0.003˜0.005 wt parts of chopped fresh green pepper, and 0.0025˜0.0029 wt parts of laurel leaf powder together with the condensed mixture prepared in the first step at 100° C.˜120° C. for half a minute to one minute; a third step of admixing the panbroiled mixture prepared in the second step with 0.020˜0.025 wt parts of boiled leg bone broth and 0.035˜0.045 wt parts of Korean hot pepper paste; combining the admixture prepared in the third step with 0.0025˜0.0029 wt parts of basil powder, 0.0025˜0.0029 wt parts of marjoram powder, 0.00050˜0.00060 wt parts of oregano powder, 0.0025˜0.0029 wt parts of clove powder, 0.0025˜0.0029 wt parts of rosemary powder, 0.00050˜0.00060 wt parts of paprika powder, 0.0050˜0.0060 wt parts of starch syrup, and 0.0025˜0.0029 wt parts of soju and heating the resulting combination at 100° C.˜140° C. for 6 to 12 minutes; a fifth step of mixing the heated combination prepared in the fourth step with 0.00080˜0.00084 wt parts of glutinous rice powder and heating the mixture at 60° C.˜100° C. for 1 to 5 minutes; and a sixth step of mixing the heated mixture prepared in the fifth step with 0.00010˜0.00015 wt parts of black pepper and heating the mixture at a temperature ranging from 60° C.˜100° C. for a period ranging from 15 seconds to 1 minute.

In an embodiment of the method according to the present invention, the fermented soybean paste sauce is prepared by: a seventh step of condensing 0.00092˜0.00096 wt parts of olive oil, 0.013˜0.017 wt parts of minced beef, and 0.010˜0.014 wt parts of ground fresh oysters in a preheated pan at 100° C.˜140° C. for 15 seconds to 1 minute; an eighth step of panbroiling 0.0030˜0.0032 wt parts of chopped garlic, 0.0030˜0.0032 wt parts of chopped onion, 0.00060˜0.00065 wt parts of chopped leek, 0.00030˜0.00032 wt parts of chopped ginger, 0.00030˜0.00032 wt parts of laurel leaf powder along with the condensed mixture prepared in the seventh step at 100° C.˜120° C. for half a minute to one and a half minutes; a ninth step of admixing the panbroiled mixture, prepared in the eighth step, with 0.020˜0.030 wt parts of boiled leg bone broth and 0.020˜0.030 wt parts of fermented soybean paste; a tenth step of combining the admixture prepared in the ninth step with 0.00030˜0.00032 wt parts of basil powder, 0.00030˜0.00032 wt parts of marjoram powder, 0.00060˜0.00065 wt parts of oregano powder, 0.00030˜0.00032 wt parts of clove powder, 0.00030˜0.00032 wt parts of rosemary powder, 0.0060˜0.0065 wt parts of starch syrup and 0.002˜0.004 wt parts of soju and heating the combination at 100° C.˜140° C. for 6 to 12 minutes; an eleventh step of mixing the heated combination prepared in the tenth step with 0.00092˜0.00096 wt parts of glutinous rice powder and heating them at 60° C.˜100° C. for 1 to 5 minutes; and a twelfth step of mixing the heated mixture prepared in the eleventh step with 0.00014˜0.00016 wt parts of black pepper and heating them at 60° C.˜100° C. for 15 seconds to 1 minute.

In accordance with an embodiment of the method, the soy sauce is prepared by: a thirteenth step of condensing 0.00090˜0.00095 wt parts of olive oil and 0.015˜0.025 wt parts of minced beef in a preheated container at 100° C.˜140° C. for a period ranging from 15 seconds to 1 minute; a fourteenth step of panbroiling 0.0040˜0.0043 wt parts of chopped garlic, 0.0040˜0.0043 wt parts of chopped onion, 0.00080˜0.00084 wt parts of chopped leek, 0.00040˜0.00042 wt parts of chopped ginger, 0.0015˜0.0025 wt parts of chopped fresh green pepper, and 0.00040˜0.00042 wt parts of laurel leaf powder together with the condensed mixture prepared in the thirteenth step at 100° C.˜120° C. for half a minute to one and a half minutes; a fifteenth step of admixing the mixture prepared in the fourteenth step with 0.014˜0.018 wt parts of boiled leg bone broth and 0.030˜0.035 wt parts of soy sauce; a sixteenth step of combining the admixture prepared in the fifteenth step with 0.00040˜0.00042 wt parts of basil powder, 0.00040˜0.00042 wt parts of marjoram powder, 0.00080˜0.00082 wt parts of oregano powder, 0.00040˜0.00042 wt parts of clove powder, 0.00040˜0.00042 wt parts of rosemary powder, 0.0080˜0.0084 wt parts of starch syrup and 0.0040˜0.0042 wt parts of soju and heating them at 100° C.˜140° C. for 6 to 12 minutes; a seventeenth step of mixing the heated combination prepared in the sixteenth step with 0.0015˜0.0025 wt parts of glutinous rice powder and heating the resulting mixture at 60° C.˜100° C. for 1 to 5 minutes; and an eighteenth step of adding 0.00015˜0.00025 wt parts of black pepper to the heated mixture prepared according to the seventeenth step and heating the resulting mixture at 60° C.˜100° C. for 15 seconds to 1 minute.

In accordance with an embodiment of the method, the seafood is prepared by mincing 0.03˜0.08 wt parts of one or more kinds of seafood selected from among shrimp, clam meat, squid, and fish roe, condensing the seafood with 0.001˜0.002 wt parts of olive oil in a preheated pan at 100° C.˜140° C. for half a minute to 1 minute, and mixing the condensed seafood with 0.0005˜0.0010 wt parts of black pepper.

In accordance with an embodiment of the method of present invention, the meat is prepared by mincing 0.03˜0.08 wt parts of one or more kinds of meat selected from among beef, pork, chicken, and duck, condensing the meat prepared above with 0.001˜0.002 wt parts of olive oil in a preheated pan at 100° C.˜140° C. for half a minute to 1 minute, and mixing the condensed meat prepared above with 0.0005˜0.0010 wt parts of black pepper.

In accordance with an embodiment of the method of the present invention, the fried kimchi is prepared by condensing 0.001˜0.002 wt parts of olive oil and 0.03˜0.08 wt parts of chopped cabbage kimchi in a preheated pan at 100° C.˜140° C. for half a minute to 1 minute and mixing the kimchi with 0.002˜0.003 wt parts of sugar and 0.0005˜0.0010 wt parts of black pepper.

In the method, the extruder comprises a hopper for feeding the steamed rice cake, an extrusion screw, positioned below the hopper, for extruding the steamed rice cake fed from the hopper, and an extrusion body for housing the extrusion screw, provided at one end thereof with a shaping unit, said shaping unit comprising: a feed pipe, connected to the extruder, for transferring the steamed rice cake extruded from the extrusion body into the shaping unit, said feed pipe being tapered toward the shaping unit; and an assembly of a rice cake support, a plurality of spacers, and a lid, provided at the other end of the feed pipe, for determining the size and form of the steamed rice cake, said rice cake support being provided for accommodating and supporting the steamed rice cake extruded from the extrusion body, said spacers being positioned between the rice cake support and the lid, being aligned with the opposite sides of both the rice cake support and the lid and being adapted to determine the size of the steamed rice cake accommodated by the rice cake support, said lid having a contour corresponding to that of the rice cake support and being placed on the spacers and aligned with the outside of the support.

### ADVANTAGEOUS EFFECTS

Rice pizza in the present invention integrates Korea's traditional steamed rice cake with various traditional pastes, such as thick soy paste mixed with red peppers, fermented soybean paste, and soy sauce, so that this rice pizza converts some of the adult-disease-causing ingredients of pizza into traditional high-quality food products.

Further, as this rice pizza mainly uses steamed rice cake, it has a positive impact on promoting rice consumption at home.

### BRIEF DESCRIPTION OF THE DRAWINGS

FIG. 1 is a flow chart illustrating a manufacturing method for rice pizza according to a preferred embodiment of the present invention;

FIG. 2 is a schematic diagram showing an apparatus for manufacturing rice cake dough in accordance with a preferred embodiment of the present invention;

FIG. 3 is a perspective view showing a disassembled shaping unit of the apparatus for manufacturing rice cake-based dough in a preferred embodiment of the present invention; and

FIG. 4 is a perspective view showing an assembled shaping unit of the apparatus for manufacturing rice cake-based dough in a preferred embodiment of the present invention.

### BEST MODE FOR CARRYING OUT THE INVENTION

With reference to the attached drawings, the manufacturing method for rice pizza will be explained in detail below.

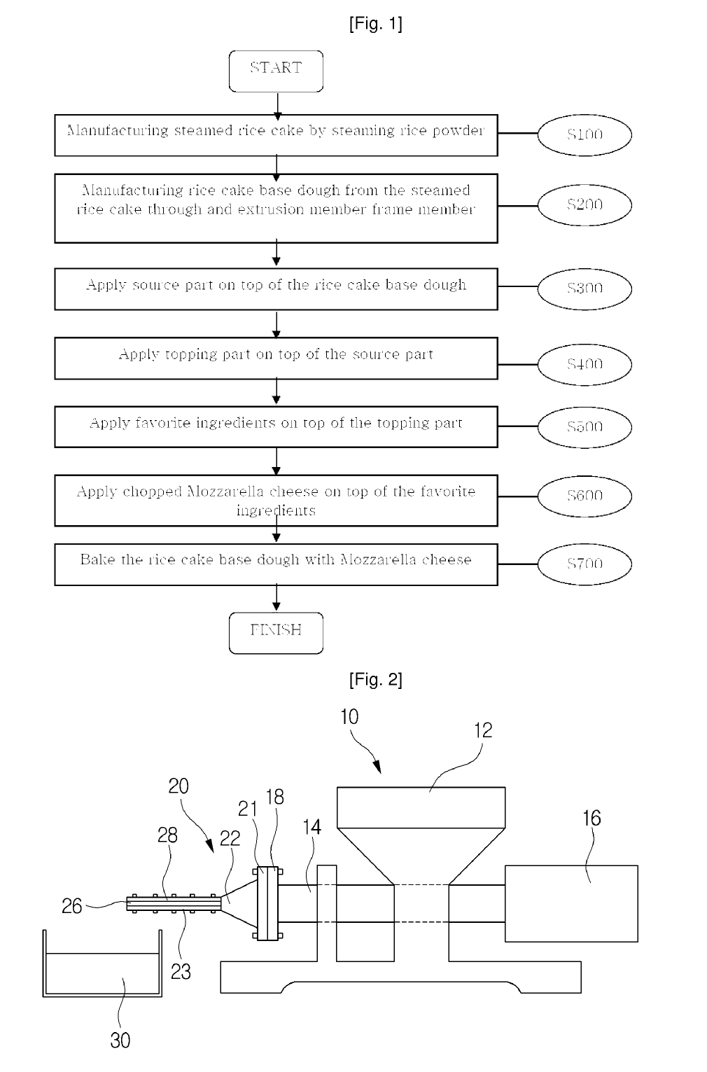

FIG. 1 is a flow chart illustrating a manufacturing method for rice pizza according to a preferred embodiment of the present invention, comprising: a step of preparing steamed rice cake by steaming rice powder (S100); a step of preparing a rice cake-based dough from the steamed rice cake using an extruder (10) and a shaping unit (20) (S200); a sauce spreading step (S300) of applying sauce on top of the rice cake-based dough; a topping step (S400) of placing toppings on top of the sauce; a favorite ingredient placement step (S500) of placing additional toppings on top of the toppings; a Mozzarella cheese placement step (S600) of placing chopped Mozzarella cheese on top of the favorite ingredients; a baking step (S700) of baking rice cake-based dough with Mozzarella cheese scattered on top of the dough in an oven.

The rice cake-based dough preparing step (S100) refers to a step of preparing dough from rice. In this step, 1 wt part of rice powder is placed in an earthenware steamer and steamed at a temperature raging from 100° C.˜250° C. for a period ranging from 15 to 40 minutes.

During this step, food additives of 0.01˜0.30 wt parts of can be added to the rice powder to enhance the dough's characteristic color, flavor, and nutritional value.

Desirably, the additives may include one or more kinds of additive selected from among green tea powder, banaba powder, blackberry powder, arrowroot powder, herb powder, cocoa powder, caramel powder, schizandra berry powder, cherry powder, gardenia powder, mugwort powder, red hot peppers powder powder, Calostoma powder, jujube powder, sweetened red-bean paste powder, and corn powder.

For the preparation of rice cake-based dough from steamed rice cake, an apparatus comprising an extruder 10 and a shaping unit 20 is used. With reference to FIGS. 2 to 4, a detailed description is given of the apparatus for preparing the rice cake-based dough. As shown in FIG. 2, the extruder 10 comprises a hopper 12 for feeding the steamed rice cake prepared in the prior step, an extrusion screw (not shown), positioned below the hopper 12, for extruding the steamed rice cake fed from the hopper 12 as a result of rotation by a driving motor 16, and an extrusion body 14 for housing the extrusion screw, the extrusion body being equipped at one end thereof with a first connector 18 for connecting with the shaping unit 20. Thus, while being extruded through the extrusion body 14, the rice cake is transferred into the shaping unit 20.

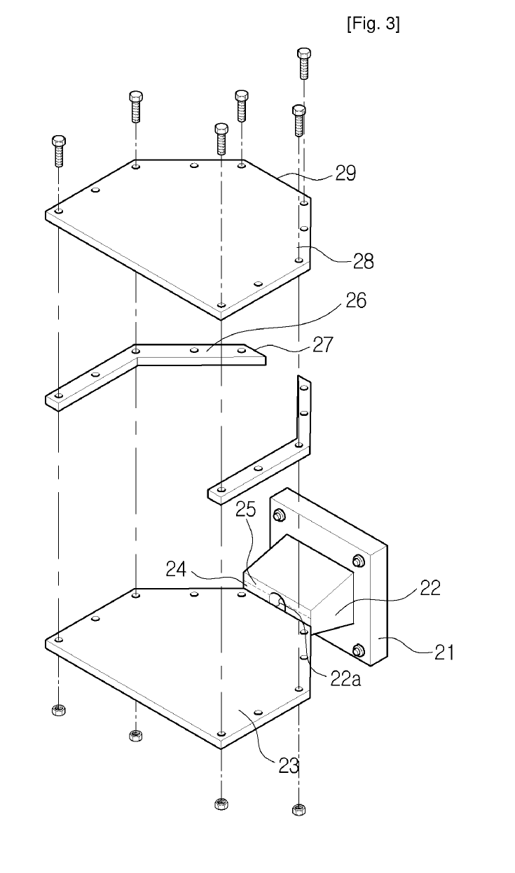

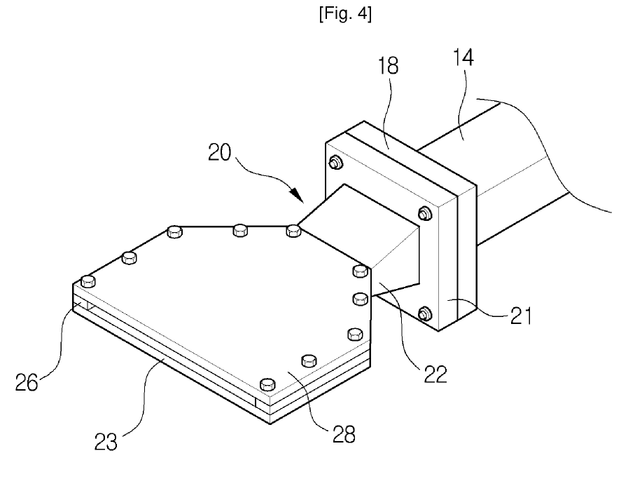

Referring to FIGS. 3 and 4, the shaping unit 20 is shown in a disassembled perspective view and an assembled perspective view, respectively. As seen in these figures, the shaping unit 20 is located so as to be connected to the extrusion body 14 and is structured to receive the steamed rice cake from the extrusion body 14 and shape the steamed rice cake into a predetermined form. The shaping unit 20 comprises a feed pipe 22, a second connector 21, a rice cake support 23, a spacer 26 and a lid 28.

The feed pipe 22, adapted to transfer the steamed rice cake extruded from the extrusion body 14 into the shaping unit 20, is provided at one end thereof with a second connector 21 joined with the first connector 18 and at the other end thereof with an assembly of the rice cake support 23, the spacer 26 and the lid 28. The rice cake support 23 and the lid 28 are positioned at a lower portion and an upper position of the feed pipe 22, with the spacer 26 intercalated therebetween.

The feed pipe 22 is tapered so that the steamed rice cake is transferred at higher speeds as it goes toward the shaping unit.

Provided for accommodating and supporting the steamed rice cake extruded from the extrusion body, the rice cake support 23, positioned at a lower portion of the feed pipe 22, has a predetermined size and plate shape.

The spacer 26, consisting of a pair of bars, functions to determine the size of the rice cake to be accommodated within the space of the assembly. The spacer 26 is provided at one end thereof with a middle adaptor 27 lined with the feed pipe 22 at a corresponding terminal middle position and its outer side is aligned with the corresponding side of the rice cake support 23, so that the components thereof are spaced apart from each other on the rice cake support 23, thereby determining the size of the rice cake that can be accommodated within the space of the assembly.

The spacer 26 may be composed of a plurality of bars, each having a desired length and a desired height. For example, the spacer 26 preferably ranges in length from 50 mm to 500 mm and in height from 1 mm to 30 mm.

The lid 28, having a contour corresponding to that of the rice cake support 23, is placed on the upper surface of the spacer 26 and is aligned with the outside of the support 26. The lid 28 is provided at one end thereof with an upper adaptor 29 lined with the feed pipe 22 at a corresponding terminal upper position.

When introduced into the space of the assembly, the steam rice cake is confined therein, and then comes out as dough in a predetermined pattern.

In the structure of the apparatus for preparing rice-cake based dough, the steamed rice cake prepared in the rice cake-based dough preparing step (S100), after being introduced into the extrusion body 14 through the hopper 12, is extruded in the direction of the shaping unit as the extrusion screw rotates.

While it is extruded from the extrusion body 14 to the shaping unit 20, the steamed rice cake comes out of the shaping unit 20 as dough having a predetermined size and pattern.

The resulting dough in a predetermined form is introduced into a cold-water tub 30 spaced apart from the shaping unit 20 by a predetermined distance.

Because the cold-water tub 30 contains cold water, the dough in the cold-water tub 30 becomes cold, with the concomitant loss of adhesiveness.

Just prior to introduction into the cold-water tub, the nascent dough is cut into a round or square form suitable for the manufacture of pizza using a cutter.

Thus, the cutter may move in a piston type motion to cut the dough, and thus has a preferable round or square contour. The cutter may be a typical one, and thus an explanation of the details thereof is omitted.

As for the rice cake-based dough described above, more than one piece of rice cake-based dough can be prepared. In the case that two or more pieces of dough are prepared, 0.04˜0.15 wt parts of Mozzarella cheese is placed between the pieces of dough. When the rice cake-based dough is baked in the oven, the Mozzarella cheese is melted so that it helps the multiple layers of dough stick to each other, making the pizza more delicious.

In the sauce spreading step (S300) of placing sauce on top of the rice cake-based dough described above, Korean traditional sauces are used instead of western-style sauces conventionally used for manufacturing pizza. This helps integrate Korea's unique culture into western style food and provides high-quality food rich in flavor and nutrition.

The sauce comprises one of the pastes selected from among thick soy paste mixed with red peppers, fermented soybean paste, and soy sauce. 0.05˜0.15 wt parts of the selected paste is placed on top of the rice cake-based dough.

The method of manufacturing sauce of thick soy paste mixed with red peppers is as follows. 0.0007˜0.0009 wt parts of olive oil and 0.010˜0.015 wt parts of minced beef are placed in a preheated pan and condensed at a temperature ranging from 100° C.˜140° C. for a period ranging from 15 seconds˜1 minute. Then, 0.0025˜0.0029 wt parts of chopped garlic, 0.0025˜0.0029 wt parts of chopped onion, 0.00050˜0.00060 wt parts of chopped leek, 0.0025˜0.0029 wt parts of chopped ginger, 0.003˜0.005 wt parts of chopped fresh green pepper, and 0.0025˜0.0029 wt parts of laurel leaf powder are added and condensed therewith at a temperature ranging from 100° C.˜120° C. for a period ranging from half a minute to 1 minute. The next step is to mix the condensed mixture with 0.020˜0.025 wt parts of boiled leg bone broth, 0.035˜0.045 wt parts of thick soy paste mixed with red peppers, 0.0025˜0.0029 wt parts of basil powder, 0.0025˜0.0029 wt parts of marjoram powder, 0.00050˜0.00060 wt parts of oregano powder, 0.0025˜0.0029 wt parts of clove powder, 0.0025˜0.0029 wt parts of rosemary powder, 0.00050˜0.00060 wt parts of paprika powder, 0.0050˜0.0060 wt parts of starch syrup, and 0.0025˜0.0029 wt parts of soju. After mixing, the entire mixture is heated at a temperature ranging from 100° C.˜140° C. for a period ranging from 6 to 12 minutes. The final step for manufacturing sauce of Korean traditional thick soy paste mixed with red peppers is to mix the prepared ingredients with 0.00080˜0.00084 wt parts of glutinous rice powder and heat the mixture at a temperature ranging from 60° C.˜100° C. for a period ranging from 1 to 5 minutes.

The method of manufacturing sauce of thick soy paste mixed with red peppers is as follows. 0.00092˜0.00096 wt parts of olive oil, 0.013˜0.017 wt parts of minced beef, and 0.010˜0.014 wt parts of ground fresh oysters are placed in a preheated pan and condensed at a temperature ranging from 100° C.˜140° C. for a period ranging from 15 seconds˜1 minute. Then, 0.0030˜0.0032 wt parts of chopped garlic, 0.0030˜0.0032 wt parts of chopped onion, 0.00060˜0.00065 wt parts of chopped leek, 0.00030˜0.00032 wt parts of chopped ginger, and 0.00030˜0.00032 wt parts of laurel leaf powder were added to the condensed mixture prepared above and condensed therewith at a temperature ranging from 100° C.˜120° C. for a period ranging from half a minute to one and a half minutes. Then, the condensed mixture was mixed with 0.020˜0.030 wt parts of boiled leg bone broth, 0.020˜0.030 wt parts of fermented soybean paste, 0.00030˜0.00032 wt parts of basil powder, 0.00030˜0.00032 wt parts of marjoram powder, 0.00060˜0.00065 wt parts of oregano powder, 0.00030˜0.00032 wt parts of clove powder, 0.00030˜0.00032 wt parts of rosemary powder, 0.0060˜0.0065 wt parts of starch syrup and 0.002˜0.004 wt parts of soju. After mixing, the entire mixture was heated at a temperature ranging from 100° C.˜140° C. for a period ranging from 6 to 12 minutes. The next step is to mix the prepared ingredients with 0.00092˜0.00096 wt parts of glutinous rice powder and heat the mixture at a temperature ranging from 60° C.˜100° C. for a period ranging from 1 to 5 minutes. The final step for manufacturing Korean traditional fermented soybean paste is to add 0.00014˜0.00016 wt parts of black pepper to the heated mixture and heat them at a temperature ranging from 60° C.˜100° C. for a period ranging from 15 seconds to 1 minute.

The method of manufacturing soy sauce is as follows. 0.00090˜0.00095 wt parts of olive oil and 0.015˜0.025 wt parts of minced beef are placed in a preheated pan and condensed at a temperature ranging from 100° C.˜140° C. for a period ranging from 15 seconds˜1 minute. Then 0.0040˜0.0043 wt parts of chopped garlic, 0.0040˜0.0043 wt parts of chopped onion, 0.00080˜0.00084 wt parts of chopped leek, 0.00040˜0.00042 wt parts of chopped ginger, 0.0015˜0.0025 wt parts of chopped fresh green pepper, and 0.00040˜0.00042 wt parts of laurel leaf powder are added to the mixture and condensed therewith at a temperature ranging from 100° C.˜120° C. for a period ranging from half a minute to one and a half minutes. Then, the condensed mixture is mixed with 0.014˜0.018 wt parts of boiled leg bone broth, 0.030˜0.035 wt parts of soy sauce, 0.00040˜0.00042 wt parts of basil powder, 0.00040˜0.00042 wt parts of marjoram powder, 0.00080˜0.00082 wt parts of oregano powder, 0.00040˜0.00042 wt parts of clove powder, 0.00040˜0.00042 wt parts of rosemary powder, 0.0080˜0.0084 wt parts of starch syrup and 0.0040˜0.0042 wt parts of soju. After mixing, the mixture is heated at a temperature ranging from 100° C.˜140° C. for a period ranging from 6 to 12 minutes. The next step is to mix the prepared ingredients with 0.0015˜0.0025 wt parts of glutinous rice powder and heat them at a temperature ranging from 60° C.˜100° C. for a period ranging from 1 to 5 minutes. The final step for manufacturing Korean traditional soy sauce is to add 0.00015˜0.00025 wt parts of black pepper to the heated mixture and heat them at a temperature ranging from 60° C.˜100° C. for a period ranging from 15 seconds to 1 minute.

The sauce, selected from among sauce of thick soy paste mixed with red peppers, fermented soybean paste, and soy sauce, manufactured in accordance with the methods described above, is spread on top of the rice cake-based dough. In order to express the unique flavor of each paste, it is desirable that the sauce that is to be placed on top of the rice cake-based dough be one of the sauces selected from among sauce of thick soy paste mixed with red peppers, fermented soybean paste, and soy sauce.

In the topping step (S400) of placing toppings on top of the sauce, 0.03˜0.08 wt parts of selected toppings selected from among seafood, meat, and fried kimchi are placed on top of the sauce. Theses toppings are ingredients that are produced by Korean farmers and fishermen.

The method of preparing seafood is as follows. 0.03˜0.08 wt parts of one or more kinds of seafood is selected from among shrimp, clam meat, squid, and fish roe. The selected seafood is chopped and then condensed with 0.001˜0.002 wt parts of olive oil in a preheated pan at a temperature ranging from 100° C.˜140° C. for a period ranging from half a minute to 1 minute. Lastly, 0.0005˜0.0010 wt parts of black pepper is mixed therewith.

The method of preparing meat is as follows. 0.03˜0.08 wt parts of one or more kinds of meat is selected from among beef, pork, chicken, and duck. The selected meat is chopped and then condensed with 0.001˜0.002 wt parts of olive oil in a preheated pan at a temperature ranging from 100° C.˜140° C. for a period ranging from half a minute to 1 minute. Lastly, 0.0005˜0.0010 wt parts of black pepper is mixed therewith.

The method of preparing fried kimchi is as follows. 0.03˜0.08 wt parts of chopped cabbage kimchi is mixed with 0.001˜0.002 wt parts of olive oil in a preheated pan at a temperature ranging from 100° C.˜150° C. for a period ranging from half a minute to 1 minute. Lastly, 0.002˜0.003 wt parts of sugar and 0.0005˜0.0010 wt parts of black pepper are mixed therewith.

In the favorite food placement step (S500) of placing favorite food on top of the topping described above, the user can add his or her favorite ingredients as desired. In this step, 0.02˜0.05 wt parts of one or more kinds of fruit selected from among pineapple, apple, peach, watermelon, orange, strawberry, kiwi fruit, pear, persimmon, and tomato, and one or more favorite ingredients selected from among 0.02˜0.05 wt parts of sausage, 0.02˜0.05 wt parts of mushrooms, 0.02˜0.05 wt parts of olives, 0.02˜0.05 wt parts of green pepper, 0.02˜0.05 wt parts of potato, 0.02˜0.05 wt parts of sweet pumpkin, and 0.02˜0.05 wt parts of sweet potato are placed on top of the topping.

The mozzarella cheese placement step (S600) of spreading mozzarella cheese on top of the favorite food is designed to prevent ingredients from displacement and movement and to enhance flavor. In this step, 0.10˜0.22 wt parts of mozzarella cheese is evenly scattered on top of the favorite food.

The mozzarella cheese baking step (S700) of baking the rice cake-based dough with mozzarella cheese scattered on it is intended to melt mozzarella cheese placed on top of the favorite food. In this step, mozzarella cheese is baked in an oven preheated to 270° C.˜330° C. for a period ranging from 2˜3 minutes. As the Mozzarella cheese melts, it becomes tightly stuck to the top of the favorite ingredients.

The present invention will be explained with reference to the following examples. However, the present invention is not limited to these examples.

### EXAMPLES

### Example 1

### Manufacturing Steamed Rice Cake and Rice Cake-Based Dough

1 wt part of rice powder was placed in an earthenware steamer and steamed at 200° C. for a period ranging from 25 minutes to make steamed rice cake. This steamed rice cake was formed into round-shaped rice cake-based dough after passing through an extruder, a shaping unit, and a cutter. Two pieces of the manufactured rice cake-based dough were prepared and 0.10 wt parts of Mozzarella cheese was evenly scattered between the two pieces.

### Manufacturing Sauce of Thick Soy Paste Mixed with Red Peppers

0.0008 wt parts of olive oil and 0.013 wt parts of minced beef were condensed in a preheated pan at a temperature of 120° C. for half a minute. Then, 0.0028 wt parts of chopped garlic, 0.0028 wt parts of chopped onion, 0.00056 wt parts of chopped leek, 0.0028 wt parts of chopped ginger, 0.004 wt parts of chopped fresh green pepper, and 0.0028 wt parts of laurel leaf powder were added to the mixture, and then the entire mixture was condensed at a temperature of 110° C. for one more minute. Then the condensed mixture was mixed with 0.0024 wt parts of boiled leg bone broth, 0.042 wt parts of thick soy paste mixed with red peppers, 0.0028 wt parts of basil powder, 0.0028 wt parts of marjoram powder, 0.00057 wt parts of oregano powder, 0.0028 wt parts of clove powder, 0.0028 wt parts of rosemary powder, 0.00056 wt parts of paprika powder, 0.0056 wt parts of starch syrup, and 0.0028 wt parts of soju. The mixture was heated at a temperature of 110° C. for 8 minutes. Then, the mixture prepared above was mixed with 0.00083 wt parts of glutinous rice powder and heated at a temperature of 80° C. for 3 minutes. Lastly, the mixture prepared above was mixed with 0.00013 wt parts of black pepper and heated at a temperature of 80° C. for 45 seconds.

### Preparing Meat

0.08 wt parts of beef was minced and condensed with 0.002 wt parts of olive oil in a preheated pan at a temperature of 140° C. for half a minute. Then, 0.0010 wt parts of black pepper was added thereto.

### Manufacturing Pizza

0.11725 wt parts of sauce of thick soy paste mixed with red peppers was applied evenly to the top of the rice cake-based dough, and 0.08 wt parts of meat was placed on top of the sauce. Then, favorite ingredients, comprising 0.02 wt parts of half moon shaped sausage, 0.05 wt parts of apple, 0.03 wt parts of potato, 0.02 wt parts of sweet pumpkin, and 0.02 wt parts of sweet potato, were cut into predetermined shapes as desired and placed on top of the meat at regular intervals.

0.22 wt parts of mozzarella cheese was placed on top of the favorite food. Then the pizza was baked in an oven preheated to 300° C. for 2 minutes. As the mozzarella cheese melted, the meat and favorite food became tightly stuck to the rice cake-based dough.

### Example 2

### Manufacturing Steamed Rice Cake and Rice Cake-Based Dough Containing Green Tea

1 wt part of rice powder and 0.03 wt parts of green tea were placed in an earthenware steamer and steamed at 250° C. for 15 minutes to make steamed rice cake. This steamed rice cake was formed into pieces of round-shaped rice cake-based dough after passing through an extruder, a shaping unit, and a cutting member. Three such manufactured pieces of rice cake-based dough were prepared. Two portions of 0.05 wt parts of mozzarella cheese were evenly scattered between the first and the second piece and between the second and the third piece, respectively.

### Manufacturing Fermented Soybean Paste Sauce

0.00093 wt parts of olive oil, 0.014 wt parts of minced beef, and 0.011 wt (%) ground fresh oysters were condensed in a preheated pan at a temperature of 100° C. for one minute. Then, 0.0031 wt parts of chopped garlic, 0.0031 wt parts of chopped onion, 0.00062 wt parts of chopped leek, 0.00031 wt parts of chopped ginger, and 0.00031 wt parts of laurel leaf powder were added to the mixture, and then the entire mixture was condensed at a temperature of 100° C. for one and a half minutes. Then the condensed mixture was mixed with 0.0023 wt parts of boiled leg bone broth, 0.024 wt parts of fermented soybean paste, 0.00031 wt parts of basil powder, 0.00031 wt parts of marjoram powder, 0.00062 wt parts of oregano powder, 0.00031 wt parts of clove powder, 0.00030 wt parts of rosemary powder, 0.00056 wt parts of paprika powder, 0.0062 wt parts of starch syrup, and 0.003 wt parts of soju. The mixture was heated at a temperature of 110° C. for 10 minutes. Then, the mixture prepared above was mixed with 0.00093 wt parts of glutinous rice powder and heated at a temperature of 70° C. for 4 minutes. Lastly, the mixture prepared above was mixed with 0.00015 wt parts of black pepper and heated at a temperature of 70° C. for 45 seconds.

### Preparing Seafood

0.03 wt parts of clam meat was minced and condensed with 0.001 wt parts of olive oil in a preheated pan at a temperature of 140° C. for half a minute. Then, 0.0005 wt parts of black pepper was added.

### Manufacturing Pizza

0.0925 wt parts of fermented soybean paste sauce was applied evenly to the top of the rice cake-based dough, and 0.03 wt parts of seafood was placed on top of the sauce. Then, favorite ingredients, comprising 0.05 wt parts of green pepper, 0.02 wt parts of mushrooms, 0.03 wt parts of peaches, 0.05 wt parts of potato, 0.05 wt parts of sweet pumpkin, and 0.02 wt parts of sweet potato, were cut into predetermined shapes as desired and placed evenly on top of the seafood.

0.15 wt parts of mozzarella cheese was placed on top of the favorite food. Then the pizza was baked in an oven preheated to 330° C. for 2 minutes. As the mozzarella cheese melted, the seafood and favorite food became tightly stuck to the rice cake-based dough.

### Example 3

### Manufacturing Steamed Rice Cake and Rice Cake-Based Dough Containing Mugwort

1 wt part of rice powder and 0.30 wt parts of mugwort were placed in an earthenware steamer and steamed at 100° C. for 40 minutes to make steamed rice cake. This steamed rice cake was formed into square-shaped rice cake-based dough after passing through an extruder, a shaping unit, and a cutting member.

### Manufacturing Sauce of Thick Soy Paste Mixed with Red Peppers

Olive oil 0.0009 wt parts of and 0.015 wt parts of minced beef were condensed in a preheated pan at a temperature of 140° C. for one minute. And 0.0029 wt parts of chopped garlic, 0.0029 wt parts of chopped onion, 0.0006 wt parts of chopped leek, 0.0029 wt parts of chopped ginger, 0.005 wt parts of chopped fresh green pepper, and 0.0029 wt parts of laurel leaf powder were added to the mixture, and then the entire mixture was condensed together at a temperature of 120° C. for one and a half minutes. Then the condensed mixture was mixed with 0.0025 wt parts of boiled leg bone broth, 0.045 wt parts of thick soy paste mixed with red peppers, 0.0029 wt parts of basil powder, 0.0029 wt parts of marjoram powder, 0.0006 wt parts of oregano powder, 0.0029 clove powder, 0.0029 wt parts of rosemary powder, 0.0006 wt parts of paprika powder, 0.006 wt parts of starch syrup, and 0.0029 wt parts of soju. The mixture was heated at a temperature of 120° C. for 9 minutes. Then, the mixture prepared above was mixed with 0.00084 wt parts of glutinous rice powder and heated at a temperature of 100° C. for 1 minute. Lastly, the mixture prepared above was mixed with 0.0001 wt parts of black pepper and heated at a temperature of 80° C. for half a minute.

### Preparing Fried Kimchi

0.04 wt parts of chopped cabbage kimchi and 0.001 wt parts of olive oil were condensed in a preheated pan at a temperature of 140° C. for half a minute. Then, 0.003 wt parts of sugar and 0.0005 wt parts of black pepper were added.

### Manufacturing Pizza

0.10324 wt parts of sauce of thick soy paste mixed with red peppers was applied evenly to the top of the rice cake-based dough and 0.04 wt parts of fried kimchi was placed on top of the sauce. Then, favorite ingredients, comprising 0.02 wt parts of half moon shaped sausage, 0.02 wt parts of apple, 0.05 wt parts of potato, 0.05 wt parts of sweet pumpkin, and 0.05 wt parts of sweet potato, were cut into predetermined shapes as desired and placed evenly on top of the fried kimchi.

0.20 wt parts of mozzarella cheese was placed on top of the favorite food. Then the pizza was baked in an oven preheated to 270° C. for 3 minutes. As the mozzarella cheese melted, the fried kimchi and favorite food became tightly stuck to the rice cake-based dough.

### Example 4

### Manufacturing Steamed Rice Cake and Rice Cake-Based Dough Containing Banaba

1 wt part of rice powder and 0.06 wt parts of banaba were placed in an earthenware steamer and steamed at 250° C. for 15 minutes to make steamed rice cake. This steamed rice cake was formed into square-shaped rice cake-based dough after passing through an extruder, a shaping unit, and a cutting member.

Three pieces of the manufactured rice cake-based dough were prepared. Two portions of 0.07 wt parts of mozzarella cheese were evenly scattered between the first and the second piece and between the second and the third piece, respectively.

### Manufacturing Fermented Soybean Paste Sauce

0.00093 wt parts of olive oil, 0.014 wt parts of minced beef, and 0.011 wt parts of ground fresh oysters were condensed in a preheated pan at a temperature of 120° C. for half a minute. Then, 0.0031 wt parts of chopped garlic, 0.0031 wt parts of chopped onion, 0.00062 wt parts of chopped leek, 0.00031 wt parts of chopped ginger, and 0.00031 wt parts of laurel leaf powder were added to the mixture, and then the entire mixture was condensed together at a temperature of 120° C. for half a minute.

Then the condensed mixture was mixed with 0.0020 wt parts of boiled leg bone broth, 0.020 wt parts of fermented soybean paste, 0.00031 wt parts of basil powder, 0.00031 wt parts of marjoram powder, 0.00062 wt parts of oregano powder, 0.00033 wt parts of clove powder, 0.00031 wt parts of rosemary powder, 0.0062 wt parts of starch syrup, and 0.003 wt parts of soju. The mixture was heated at a temperature of 140° C. for 6 minutes.

Then, the mixture prepared above was mixed with 0.00094 wt parts of glutinous rice powder and heated at a temperature of 60° C. for 5 minutes. Lastly, the mixture prepared above was mixed with 0.00014 wt parts of black pepper and heated at a temperature of 60° C. for one minute.

### Preparing Meat

0.08 wt parts of duck was minced and condensed with 0.001 wt part of olive oil in a preheated pan at a temperature of 140° C. for half a minute. Then, 0.0010 wt parts of black pepper was added thereto.

### Manufacturing Pizza

0.08552 wt parts of fermented soybean paste sauce was applied evenly to the top of the rice cake-based dough and 0.08 wt parts of meat was placed on top of the sauce. Then, favorite ingredients, comprising 0.05 wt parts of potato, 0.05 wt parts of sweet pumpkin, and 0.05 wt parts of sweet potato, were cut into predetermined shapes as desired and placed evenly on top of the meat.

0.12 wt parts of mozzarella cheese was placed on top of the favorite food. Then the pizza was baked in an oven preheated to 270° C. for 3 minutes. As the mozzarella cheese melted, seafood and favorite food became tightly stuck to the rice cake-based dough.

### Example 5

### Manufacturing Steamed Rice Cake and Rice Cake-Based Dough Containing Herbs

1 wt part of rice powder and 0.09 wt parts of herbs were placed in an earthenware steamer and steamed at 150° C. for 30 minutes to make steamed rice cake. This steamed rice cake was formed into pieces of square-shaped rice cake-based dough after passing through an extruder, a shaping unit, and a cutting member.

Three pieces of the manufactured rice cake-based dough were prepared. Two portions of 0.06 wt parts of mozzarella cheese were evenly scattered between the first and the second piece and between the second and the third piece, respectively.

### Manufacturing Soy Sauce

0.00092 wt parts of olive oil and 0.016 wt parts of minced beef were condensed in a preheated pan at a temperature of 100° C. for one minute. Subsequently, 0.0043 wt parts of chopped garlic, 0.0043 wt parts of chopped onion, 0.00084 wt parts of chopped leek, 0.0004 wt parts of chopped ginger, 0.0015 wt parts of chopped fresh green pepper, and 0.0004 wt parts of laurel leaf powder were added to the mixture, and then the entire mixture was condensed together at a temperature of 110° C. for one minute.

Then the condensed mixture was mixed with 0.014 wt parts of boiled leg bone broth, 0.030 wt parts of soy sauce, 0.0004 wt parts of basil powder, 0.0004 wt parts of marjoram powder, 0.00081 wt part of oregano powder, 0.00041 clove powder, 0.00042 wt parts of rosemary powder, 0.0084 wt parts of starch syrup, and 0.004 wt parts of soju. The mixture was heated at a temperature of 140° C. for 6 minutes. Then, the mixture prepared above was mixed with 0.0025 wt parts of glutinous rice powder and heated at a temperature of 100° C. for 1 minute. Lastly, the mixture prepared above was mixed with 0.00025 wt parts of black pepper and heated at a temperature of 60° C. for 1 minute.

### Preparing Seafood

0.08 wt parts of shrimp meat was minced and condensed with 0.001 wt part of olive oil in a preheated pan at a temperature of 100° C. for half a minute. Then, 0.0005 wt parts of black pepper was added thereto.

### Manufacturing Pizza

0.09025 wt parts of soy sauce was applied evenly to the top of the rice cake-based dough and 0.08 wt parts of seafood was placed on top of the sauce. Then, favorite ingredients, comprising 0.05 wt parts of mushrooms, 0.05 wt parts of green pepper, 0.05 wt parts of olive, 0.02 wt parts of potato, 0.02 wt parts of sweet pumpkin, and 0.02 wt parts of sweet potato, were cut into predetermined shapes as desired and placed on top of the seafood at regular intervals.

0.18 wt parts of mozzarella cheese was placed on top of the favorite food. Then the pizza was baked in an oven preheated to 300° C. for one and an half minutes. As the mozzarella cheese melted, the seafood and favorite food became tightly stuck to the rice cake-based dough.

Although the examples described above fully explain the present invention, various modifications and adjustments are possible within the technical scope of the present invention. Further, these modifications and adjustments are included within the scope of the claims attached below.

### INDUSTRIAL APPLICABILITY

The rice pizza of the present invention includes pizza ingredients that integrate a piece of rice cake with various pastes, such as thick soy paste mixed with red peppers, fermented soybean paste, and soy sauce. As a result, the present invention converts some of pizza's adult-disease-generating ingredients into Korea's traditional high-quality food products, which promotes rice consumption among young people and ultimately at home.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A manufacturing method for rice pizza, comprising:
a step of preparing steamed rice cake by placing 1 wt part of rice powder into an earthenware steamer, performing steaming at a temperature ranging from 100° C.˜250° C. for a period ranging from 15˜40 minutes to make steamed rice cake, extruding the steamed rice cake by use of an extruder, and cutting the extrudate into round or square shaped dough;
a step of applying 0.005˜0.15 wt parts of sauce on top of the rice cake-based dough, said sauce being selected from a group consisting of Korean hot pepper paste, fermented soybean paste, and soy sauce, a topping step of placing 0.03˜0.08 wt parts of topping on top of the sauce, said topping being selected from a group consisting of seafood, meat, fried kimchi and combinations thereof;
a step of applying additional toppings comprising 0.02˜0.05 wt parts of fruit selected from a group consisting of pineapple, apple, peach, watermelon, orange, strawberry, kiwi fruit, pear, persimmon, tomato and combinations thereof, and favorite ingredients comprising one or more ingredients selected from among 0.02˜0.05 wt parts of sausages, 0.02˜0.05 wt parts of mushrooms, 0.02˜0.05 wt parts of olives, 0.02˜0.05 wt parts of green pepper, 0.02˜0.05 wt parts of potato, 0.02˜0.05 wt parts of sweet pumpkin, and 0.02˜0.05 wt parts of sweet potato, on top of the topping; and
a step of placing 0.10˜0.22 wt parts of mozzarella cheese on top of the favorite ingredients and baking the pizza in an oven preheated to 270° C.˜330° C. for a period ranging from 2˜3 minutes.

2. The method according to claim 1, wherein 1 wt part of rice powder is combined with 0.01˜0.30 wt parts of a food additive selected from a group consisting of green tea powder, banaba powder, blackberry powder, arrowroot powder, herb powder, cocoa powder, caramel powder, schizandra Berry Powder, cherry powder, gardenia powder, mugwort powder, red hot peppers powder, calostoma powder, jujube powder, sweetened red-bean paste powder, corn powder and combinations thereof.

3. The method according to claim 1, wherein the pizza comprises one or more pieces of dough and 0.04˜0.15 wt parts of mozzarella cheese is applied between the pieces of dough.

4. The method according to claim 1, wherein the Korean hot pepper sauce is prepared by:
a first step of condensing 0.0007˜0.0009 wt parts of olive oil and 0.010˜0.015 wt parts of minced beef in a preheated pan at 100° C.˜140° C. for 15 seconds˜1 minute;
a second step of panbroiling 0.0025˜0.0029 wt parts of chopped garlic, 0.0025˜0.0029 wt parts of chopped onion, 0.00050˜0.00060 wt parts of chopped leek, 0.0025˜0.0029 wt parts of chopped ginger, 0.003˜0.005 wt parts of chopped fresh green pepper, and 0.0025˜0.0029 wt parts of laurel leaf powder together with the condensed mixture prepared in the first step at 100° C.˜120° C. for half a minute to one minute:
a third step of admixing the panbroiled mixture prepared in the second step with 0.020˜0.025 wt parts of boiled leg bone broth and 0.035˜0.045 wt parts of Korean hot pepper paste,
a fourth step of combining the admixture prepared in the third step with 0.0025˜0.0029 wt parts of basil powder, 0.0025˜0.0029 wt parts of marjoram powder, 0.00050˜0.00060 wt parts of oregano powder, 0.0025˜0.0029 wt parts of clove powder, 0.0025˜0.0029 wt parts of rosemary powders 0.00050˜0.00060 wt parts of paprika powder, 0.0050˜0.0060 wt parts of starch syrup, and 0.0025˜0.0029 wt parts of soju and heating the resulting combination at 100° C.˜140° C. for 6 to 12 minutes;
a fifth step of mixing the heated combination prepared in the fourth step with 0.00080˜0.00084 wt parts of glutinous rice powder and heating the mixture at 60° C. 100° C. for 1 to 5 minutes; and
a sixth step of mixing the heated mixture prepared in the fifth step with 0.00010˜0.00015 wt parts of black pepper and heating the mixture at a temperature ranging from 60° C.˜100° C. for a period ranging from 15 seconds to 1 minute.

5. The method according to claim 1, wherein the fermented soybean paste sauce is prepared by:
a seventh step of condensing 0.00092˜0.00096 wt parts of olive oil, 0.013˜0.017 wt parts of minced beef, and 0.010˜0.014 wt parts of ground fresh oysters in a preheated pan at 100° C.˜140° C. for 15 seconds to 1 minute;
an eighth step of panbroiling 0.0030˜0.0032 wt parts of chopped garlic, 0.0030˜0.0032 wt parts of chopped onion, 0.00060˜0.00065 wt parts of chopped leek, 0.00030˜0.00032 wt parts of chopped ginger, 0.00030˜0.00032 wt parts of laurel leaf powder along with the condensed mixture prepared in the seventh step at 100° C.˜120° C. for half a minute to one and a half minutes,
a ninth step of admixing the panbroiled mixture, prepared in the eighth step, with 0.020˜0.030 wt parts of boiled leg bone broth and 0.020˜0.030 wt parts of fermented soybean paste;
a tenth step of combining the admixture prepared in the ninth step with 0.00030˜0.00032 wt parts of basil powder, 0.00030˜0.00032 wt parts of marjoram powder, 0.00060˜0.00065 wt parts of oregano powder, 0.00030˜0.00032 wt parts of clove powder, 0.00030˜0.00032 wt parts of rosemary powder, 0.0060˜0.0065 wt parts of starch syrup and 0.002˜0.004 wt parts of soju and heating the combination at 100° C.˜140° C. for 6 to 12 minutes:
an eleventh step of mixing the heated combination prepared in the tenth step with 0.00092˜0.00096 wt parts of glutinous rice powder and heating them at 60° C.˜100° C. for 1 to 5 minutes; and
a twelfth step of mixing the heated mixture prepared in the eleventh step with 0.00014˜0.00016 wt parts of black pepper and heating them at 60° C.˜100° C. for 15 seconds to 1 minute.

6. The method according to claim 1, wherein the soy sauce is prepared by:
a thirteenth step of condensing 0.00090˜0.00095 wt parts of olive oil and 0.015˜0.025 wt parts of minced beef in a preheated container at 100° C.˜140° C. for a period ranging from 15 seconds to 1 minute;
a fourteenth step of panbroiling 0.0040˜0.0043 wt parts of chopped garlic, 0.0040˜0.0043 wt parts of chopped onion, 0.00080˜0.00084 wt parts of chopped leek, 0.00040˜0.00042 wt parts of chopped ginger, 0.0015˜0.0025 wt parts of chopped fresh green pepper, and 0.00040˜0.00042 wt parts of laurel leaf powder together with the condensed mixture prepared in the thirteenth step at 100° C.˜120° C. for half a minute to one and a half minutes;
a fifteenth step of admixing the mixture prepared in the fourteenth step with 0.014˜0.018 wt parts of boiled leg bone broth and 0.030˜0.035 wt parts of soy sauce;
a sixteenth step of combining the admixture prepared in the fifteenth step with 0.00040˜0.00042 wt parts of basil powder, 0.00040˜0.00042 wt parts of marjoram powder, 0.00080˜0.00082 wt parts of oregano powder, 0.00040˜0.00042 wt parts of clove powder, 0.00040˜0.00042 wt parts of rosemary powder, 0.0080˜0.0084 wt parts of starch syrup and 0.0040˜0.0042 wt parts of soju and heating them at 100° C.˜140° C. for 6 to 12 minutes;
a seventeenth step of mixing the heated combination prepared in the sixteenth step with 0.0015˜0.0025 wt parts of glutinous rice powder and heating the resulting mixture at 60° C.˜100° C. for 1 to 5 minutes; and
an eighteenth step of adding 0.00015˜0.00025 wt parts of black pepper to the heated mixture prepared according to the seventeenth step and heating the resulting mixture at 60° C.˜100° C. for 15 seconds to 1 minute.

7. The method according to claim 1, wherein the seafood is prepared by mincing 0.03˜0.08 wt parts of one or more kinds of seafood selected from among shrimp, clam meat, squid, and fish roe, condensing the seafood with 0.001˜0.002 wt parts of olive oil in a preheated pan at 100° C.˜140° C. for half a minute to 1 minute, and mixing the condensed seafood with 0.0005˜0.0010 wt parts of black pepper.

8. The method according to claim 1, wherein the meat is prepared by mincing 0.03˜0.08 wt parts of one or more kinds of meat selected from among beef, pork, chicken, and duck, condensing the meat with 0.001˜0.002 wt parts of olive oil in a preheated pan at 100° C.˜140° C. for half a minute to 1 minute, and mixing the condensed meat prepared above with 0.0005˜0.0010 wt parts of black pepper.

9. The method according to claim 1, wherein the fried kimchi is prepared by condensing 0.001˜0.002 wt parts of olive oil and 0.03˜0.08 wt parts of chopped cabbage kimchi in a preheated pan at 100° C.˜40° C. for half a minute to 1 minute and mixing the kimchi with 0.002˜0.003 wt parts of sugar and 0.0005˜0.0010 wt parts of black pepper.

10. The method as set forth in claim 1, wherein the extruder comprises a hopper for feeding the steamed rice cake, an extrusion screw, positioned below the hopper, for extruding the steamed rice cake fed from the hopper, and an extrusion body for housing the extrusion screw, provided at one end thereof with a shaping unit, said shaping unit comprising:
a feed pipe, connected to the extruder for transferring the steamed rice cake extruded from the extrusion body into the shaping unit, said feed pipe being tapered toward the shaping unit; and
an assembly of a rice cake support, a plurality of spacers, and a lid, provided at the other end of the feed pipe, for determining the size and form of the steamed rice cake,
said rice cake support being provided for accommodating and supporting the steamed rice cake extruded from the extrusion body,
said spacers being positioned between the rice cake support and the lid, being aligned with the opposite sides of both the rice cake support and the lid, and being adapted to determine the size of the steamed rice cake accommodated by the rice cake support,
said lid having a contour corresponding to that of the rice cake support and being placed on the spacers and aligned with the outside of the support.
